(19) United States
(12) Patent Application Publication
(10) Pub. No.: US 2024/0105381 A1
(43) Pub. Date: Mar. 28, 2024

(54) COIL COMPONENT

(71) Applicant: TAIYO YUDEN CO., LTD., Tokyo (JP)

(72) Inventors: Motoki MATSUI, Tokyo (JP); Tomoo KASHIWA, Tokyo (JP)

(21) Appl. No.: 18/464,853

(22) Filed: Sep. 11, 2023

(30) Foreign Application Priority Data
Sep. 27, 2022 (JP) 2022-154018

(51) Int. Cl. H01F 27/29; H01F 1/24; H01F 1/33; H01F 17/04; H01F 41/02

(52) U.S. Cl. CPC H01F 27/292; H01F 1/24; H01F 1/33; H01F 17/045; H01F 41/0246; H01F 2017/048

(57) ABSTRACT

At least one embodiment of the present invention provides a coil component including a base body; a coil conductor provided in the base body; a first external electrode electrically connected to the coil conductor; and a second external electrode electrically connected to the coil conductor. In at least one embodiment of the present invention, the base body includes a first group of metal magnetic particles and a resin binder, where the first group of metal magnetic particles has a plurality of first metal magnetic particles, the first group of metal magnetic particles has a first average circularity greater than 0.8, each of the first metal magnetic particles contains a main component and an additive, the main component includes at least one of Fe or Ni, and the additive accounts for less than 10 wt %.

### CROSS-REFERENCE TO RELATED APPLICATIONS

This application is based on and claims the benefit of priority from Japanese Patent Application Serial No. 2022-154018 (filed on Sep. 27, 2022), the contents of which are hereby incorporated by reference in its entirety.

### TECHNICAL FIELD

The present disclosure relates to a coil component, a circuit board, an electronic device, and a method of manufacturing the coil component.

### BACKGROUND

A soft magnetic metal material has been known as a magnetic material for a coil component in the conventional art. The soft magnetic metal material has a higher saturation magnetic flux density than a ferrite material and is therefore particularly suitable for the material of a base body of a coil component through which a large amount of current flows. The base body includes a soft magnetic metal material in the form of metal magnetic particles. The metal magnetic particles are produced by granulating the soft magnetic metal material. The metal magnetic particles often have a particle size of several nanometers to several micrometers. The metal magnetic particles included in the base body each have an insulating film for preventing a short circuit between adjacent ones of the metal magnetic particles.

A base body containing metal magnetic particles is made by, for example, obtaining a resin mixture composition by mixing and kneading metal magnetic particles and resins, pouring the resin mixture composition into a mold, and applying pressure to the resin composition mixture in the mold. In other words, compression molding is employed.

The base body of a coil component is required to have high magnetic permeability. As disclosed in Japanese Patent Application Publication 2017-183655 (“the '655 Publication”), it is known that the base body can achieve improved magnetic permeability if the compression molding is performed with an increased molding pressure and the metal magnetic particles in the base body can accordingly exhibit higher filling factor. The '655 Publication points out that a low molding pressure means low magnetic permeability of the base body and that a relatively high molding pressure around 600 MPa is used in the compression molding step. Although the molding pressure depends on required magnetic permeability, it has been conventionally considered as desirable to perform the compression molding with a molding pressure from about 400 to 800 MPa.

If a molding pressure of about 400 to 800 MPa is applied to perform compression molding on magnetic materials containing metal magnetic particles, this will deform the metal magnetic particles contained in the magnetic materials. For example, FIG. 1 of the '655 Publication shows a photograph of a cross section of a base body including deformed metal magnetic particles.

As a result of the compression molding or other processes, the metal magnetic particles are deformed and have a low circularity. The metal magnetic particles have large stress strain. Base bodies containing low-circularity metal magnetic particles suffer from low magnetic permeability due to stress strain in the metal magnetic particles. If the magnetic materials are subject to a high molding pressure, the metal magnetic particles have large stress strain, thereby lowering the magnetic permeability of the base bodies significantly. Therefore, although the high molding pressure achieves a rise in magnetic permeability, which is offset at least to a certain degree by a drop in magnetic permeability resulting from the stress strain in the metal magnetic particles. In addition, the deformed metal magnetic particles may impair the insulation between the metal magnetic particles. Therefore, as the molding pressure increases to raise the magnetic permeability, the dielectric strength voltage of the magnetic base bodies disadvantageously drop. Furthermore, as the stress strain in the metal magnetic particles increases, the core loss also increases.

The stress strain in the metal magnetic particle may be eliminated by thermal treatment at high temperatures (for example, 600° C. or higher). Heating involving high temperature that can eliminate stress strain, however, can not be performed on metal composite base bodies, in which the metal magnetic particles are bound to each other by a resin binder. For this reason, it is difficult to eliminate stress strain in metal magnetic particles contained in metal composite base bodies.

### SUMMARY

An object of the invention disclosed in this specification is to relieve or reduce at least a part of the above problem. One specific object of the invention disclosed in this specification is to mitigate magnetic permeability drop and core loss, which is caused by stress strain in metal magnetic particles.

The other objects of the invention disclosed in this specification will be apparent with reference to the entire description in this specification. The invention herein may solve any other drawbacks grasped from the following description, instead of or in addition to the above drawback.

At least one embodiment of the present invention provides a coil component including a base body; a coil conductor provided in the base body; a first external electrode electrically connected to the coil conductor; and a second external electrode electrically connected to the coil conductor. In at least one embodiment of the present invention, the base body includes a first group of metal magnetic particles and a resin binder, where the first group of metal magnetic particles has a plurality of first metal magnetic particles, the first group of metal magnetic particles has a first average circularity greater than 0.8, each of the first metal magnetic particles contains a main component and an additive, the main component includes at least one of Fe or Ni, and the additive accounts for less than 10 wt %.

At least one embodiment of the present invention provides a method of manufacturing a coil component. The method includes steps of preparing a magnetic material containing a magnetic powder and a thermosetting resin; applying a molding pressure to the magnetic material and a coil conductor to produce a molded body; heating the molded body at a heating temperature equal to or higher than a curing temperature of the thermosetting resin into a base body; and providing an external electrode on the base body. In at least one embodiment of the present invention, a difference between a source material average circularity representing an average circularity of the magnetic powder and a first average circularity is equal to or less than 10% of the source material average circularity. In at least one embodiment of the present invention, the molded body includes a first group of metal magnetic particles, where the first group of metal magnetic particles has a plurality of first metal magnetic particles made from the magnetic powder, and the first group of metal magnetic particles has the first average circularity greater than 0.8.

### Advantageous Effects

At least one embodiment of the present invention can prevent a drop in magnetic permeability attributable to stress strain in metal magnetic particles in base bodies, thereby achieving improved magnetic permeability for the base bodies and reduced core loss.

### BRIEF DESCRIPTION OF THE DRAWINGS

FIG. 1 is a perspective view schematically showing a coil component according to one embodiment of the present invention.

FIG. 2 is a schematic cross-sectional view of the coil component of FIG. 1.

FIG. 3 is a schematic enlarged view of a region A of a base body shown in FIG. 2.

FIG. 4 schematically shows a cross-section of a base body of a conventional coil component.

FIG. 5 is a perspective view schematically showing a coil component according to another embodiment of the invention.

FIG. 6 is a cross-sectional view schematically showing a coil component according to still another embodiment of the present invention.

FIG. 7 is a front view schematically showing a coil component according to still another embodiment of the present invention.

FIG. 8A is a flowchart showing a method of manufacturing a coil component according to one embodiment of the present invention.

FIG. 8B is a flowchart showing a method of manufacturing a base body of a coil component according to one embodiment of the present invention.

FIG. 9A is a schematic view showing one of the steps of the method of manufacturing a coil component according to one embodiment of the present invention.

FIG. 9B is a schematic view showing one of the steps of the method of manufacturing a coil component according to one embodiment of the present invention.

FIG. 10A is a schematic view showing one of the steps of the method of manufacturing a coil component according to one embodiment of the present invention.

FIG. 10B is a schematic view showing one of the steps of the method of manufacturing a coil component according to one embodiment of the present invention.

FIG. 11 schematically illustrates how a magnetic powder deforms during compression molding.

### DESCRIPTION OF THE PREFERRED EMBODIMENTS

Various embodiments of the present invention will be described hereinafter with reference to the appended drawings. Throughout the drawings, the same components are denoted by the same reference numerals. It should be noted that the drawings do not necessarily appear in accurate scales for convenience of description. The following embodiments of the present invention do not limit the scope of the claims. The elements described in the following embodiments are not necessarily essential to solve the problem addressed by the invention.

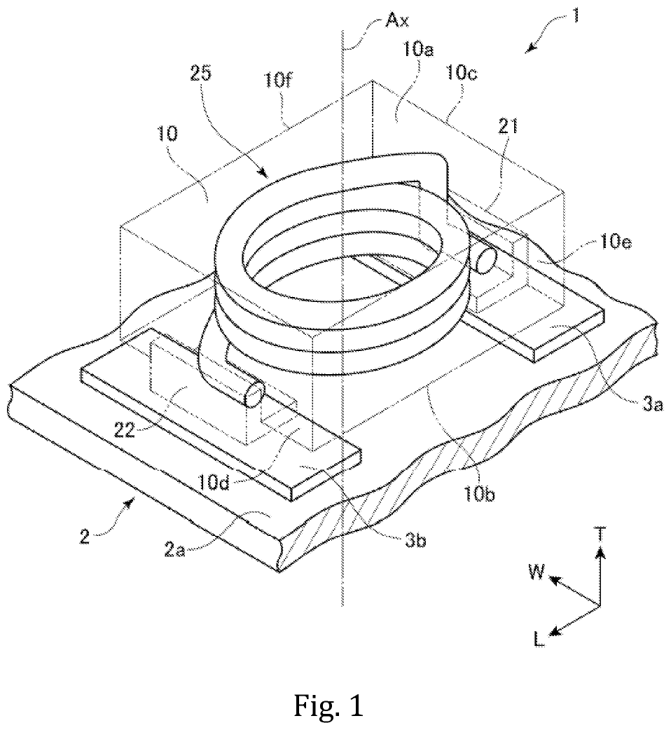

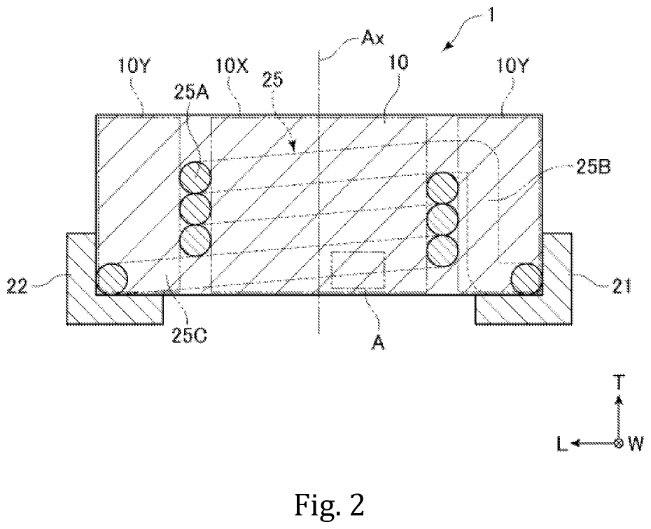

A coil component 1 according to one embodiment of the present invention will be described with reference to FIGS. 1 to 2. FIG. 1 is a schematic perspective view of the coil component 1, and FIG. 2 is a schematic cross-sectional view of the coil component 1. As shown, the coil component 1 includes a base body 10, a coil conductor 25 disposed in the base body 10, an external electrode 21 disposed on a surface of the base body 10, and an external electrode 22 disposed on a surface of the base body 10 at a location spaced apart from the external electrode 21. The base body 10 contains a magnetic material.

In this specification, the “length” direction, the “width” direction, and the “thickness” direction of the coil component 1 are interchangeable with the “L-axis” direction, the “W-axis” direction, and the “T-axis” direction defined in FIG. 1, respectively, unless otherwise construed from the context. The “thickness” direction may be also referred to as the “height” direction. The L axis, the W axis, and the T axis are perpendicular to each other.

The coil component 1 may be mounted on a mounting substrate 2a. The mounting substrate 2a has lands 3a and 3b provided thereon. The coil component 1 is mounted on the mounting substrate 2a by bonding the external electrode 21 to the land 3a and bonding the external electrode 22 to the land 3b. A circuit board 2 according to one embodiment of the present invention includes the coil component 1 and the mounting substrate 2a having the coil component 1 mounted thereon. The circuit board 2 can be mounted in various electronic devices. The electronic devices in which the circuit board 2 can be installed include smartphones, tablets, game consoles, electrical components of automobiles, servers, and various other electronic devices. For clarity, the mounting substrate 2a and the land 3a, 3b are not shown in the drawings other than FIG. 1.

The coil component 1 may be an inductor, a transformer, a filter, a reactor and any one of various other coil components. The coil component 1 may alternatively be a coupled inductor, a choke coil, and any one of various other magnetically coupled coil components. The coil component 1 may be, for example, an inductor used in a DC/DC converter. Applications of the coil component 1 are not limited to those explicitly described herein.

The base body 10 is made of magnetic material and formed in a substantially rectangular parallelepiped shape. In one embodiment of the present invention, the base body 10 is sized such that its dimension in the L-axis direction (the length) is greater than its dimension in the W-axis direction (the width) and its dimension in the T-axis direction (the height). For example, the length is from 1.0 mm to 6.0 mm, the width is from 0.5 mm to 4.5 mm, and the height is from 0.5 mm to 4.5 mm. The dimensions of the base body 10 are not limited to those specified herein. The term “rectangular parallelepiped” or “rectangular parallelepiped shape” used herein is not intended to mean solely “rectangular parallelepiped” in a mathematically strict sense. The dimensions and shape of the base body 10 are not limited to those specified herein.

The base body 10 has a first principal surface 10a, a second principal surface 10b, a first end surface 10c, a second end surface 10d, a first side surface 10e, and a second side surface 10f. The outer surface of the base body 10 is defined by these six surfaces. The first principal surface 10a and the second principal surface 10b are at the opposite ends in the height direction of the base body 10, the first end surface 10c and the second end surface 10d are at the opposite ends in the length direction of the base body 10, and the first side surface 10e and the second side surface 10f are at the opposite ends in the width direction of the base body 10. The top surface 10a and the bottom surface 10b are separated from each other by a distance equal to the height of the base body 10, the first end surface 10c and the second end surface 10d are separated from each other by a distance equal to the length of the base body 10, and the first side surface 10e and the second side surface 10f are separated from each other by a distance equal to the width of the base body 10. As shown in FIG. 1, the first principal surface 10a lies on the top side of the base body 10, and therefore, the first principal surface 10a may be herein referred to as “the top surface.” Likewise, the second principal surface 10b may be referred to as a “bottom surface.” The coil component 1 is disposed such that the second principal surface 10b faces the mounting substrate 2a, and therefore, the second principal surface 10b may be herein referred to as “the mounting surface.”

In one embodiment of the present invention, the external electrode 21 extends on the mounting surface 10b and the end surface 10c of the base body 10. The external electrode 22 extends on the mounting surface 10b and the end surface 10d of the base body 10. The external electrode 21 and the external electrode 22 are separated from each other in the length direction. Shapes and positioning of the external electrodes 21 and 22 are not limited to those in the example shown. The external electrodes 21, 22 may be formed by applying a conductive paste onto the surface of the base body 10. The conductive paste contains particles of highly conductive metals such as Ag and Cu. The external electrodes 21 and 22 may include a plated layer. The plated layer may include two or more layers. The two plating layers may include an Ni plating layer and an Sn plating layer externally provided on the Ni plating layer.

The coil conductor 25 includes a wound portion 25A wound around the coil axis Ax extending along the thickness direction (T-axis direction), a lead-out portion 25B connecting one end of the wound portion 25A to the external electrode 21, and a lead-out portion 25C connecting the other end of the wound portion 25A to the external electrode 22. In the illustrated embodiment, the coil conductor 25 has opposite ends exposed out of the base body 10, and all the other portions of the coil conductor 25 are disposed inside the base body 10. In the illustrated embodiment, the coil axis Ax intersects the first principal surface 10a and the second principal surface 10b but does not intersect the first end surface 10c, the second end surface 10d, the first side surface 10e, and the second side surface 10f. In other words, the first end surface 10c, the second end surface 10d, the first side surface 10e, the second side surface 10f extend along the coil axis Ax. In one embodiment, the coil axis Ax passes through the intersection of two diagonal lines of the base body 10, in a planar view of the base body 10. The shape of the coil conductor 25 is not limited to the illustrated one. For example, in a planar view (as viewed in the T-axis direction), the coil conductor 25 may be wound around the coil axis Ax less than a single turn. When seen in plan view, the coil conductor 25 may be shaped like an ellipse, a meander, a straight line, or a combination of these.

When the base body 10 is viewed in the direction along the coil axis Ax, the area inside the wound portion 25A is herein defined as a core area 10X, and the area outside the wound portion 25A is herein defined as a margin area 10Y. The coil conductor 25 may be wound around the coil axis Ax less than a single turn when seen in plan view, but a part of the coil conductor 25 may be wound around the coil axis Ax ⅔ turns or more (240° or greater in plan view). In such a case, the part wound ⅔ turns or more can be considered as the wound portion 25A, and the area of the base body 10 that is inside the wound portion 25A wound less than a single turn is still defined as the core area 10X, and the area of the base body 10 outside the wound portion 25A is still defined as the margin area 10Y.

The coil conductor 25 may have no wound portion wound around the coil axis Ax ⅔ turns or greater (240° or greater in plan view) but have a portion that is wound ⅔ turns or greater around any specific one of the axes extending parallel to the T axis (for example, the coil conductor 25 is shaped like a meander in plan view). In this case, the core area 10X still refers to the area of the base body 10 that is inside (close to the specific axis) the portion wound ⅔ turns or more around the specific axis in a radial direction centered on the specific axis (the radial direction extending orthogonally to the specific axis and centered on the specific axis), and the margin area 10Y still refers to the area outside the portion wound ⅔ turns or more. The coil conductor 25 may have no portion wound around the coil axis Ax ⅔ turns or greater and may also have no portion wound ⅔ turns or greater around any specific one of the axes parallel to the T axis (for example, the coil conductor 25 is shaped linearly when seen in plan view). In this case, the base body 10 has no area that can be defined as the core area 10X or margin area 10Y.

The surface of the coil conductor 25 may be covered by an insulating film composed of insulating material having a good insulation property. This insulating film may be composed of resin having a good insulation property, such as polyurethane, polyamide imide, polyimide, polyester, polyester imide. The base body 10 may include a substrate composed of insulation material having a good insulation property, and the coil conductor 25 may be formed on the substrate.

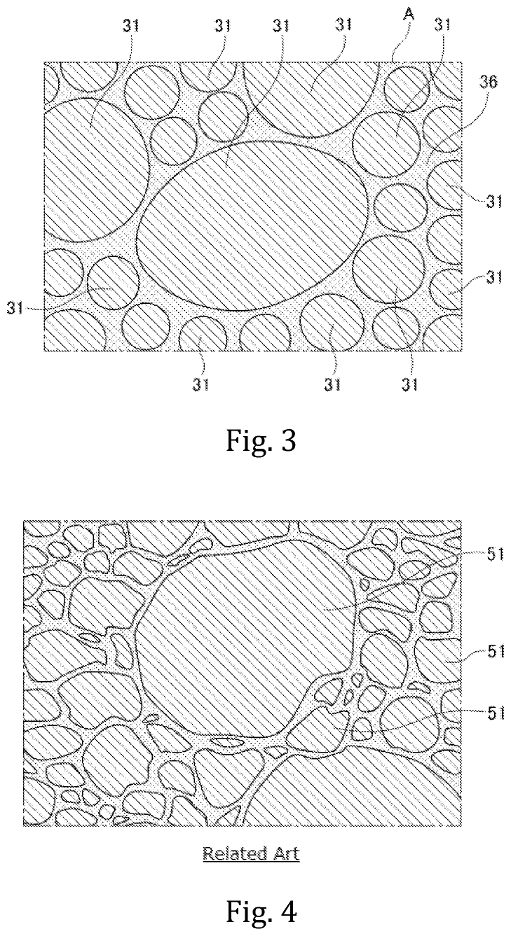

In one embodiment of the present invention, the base body 10 is composed of a magnetic material containing metal magnetic particles. The following now describes the microstructure of the base body 10 with reference to FIG. 3. FIG. 3 is an enlarged sectional view schematically showing a section of the base body 10. Specifically, FIG. 3 is an enlarged view of a region A specified in FIG. 2. FIG. 2 shows a section of the coil component 1 along a plane passing through the coil axis Ax, and the region A is a part of the section of the base body 10 shown in FIG. 2.

As shown in FIG. 3, the base body in one embodiment contains a plurality of first metal magnetic particles 31. The first metal magnetic particles 31 included in the base body 10 may be herein referred to as a first group of metal magnetic particles.

The first metal magnetic particles 31 are composed of a soft magnetic metal material. The first metal magnetic particles 31 contains at least one of Fe or Ni as the main component. The first metal magnetic particles 31 are mainly composed of Fe, Ni or an Fe—Ni alloy, for example. In the first metal magnetic particles 31, an additive accounts for less than 10 wt %. The first metal magnetic particles 31 may contain Si as the additive. The first metal magnetic particles 31 may be free of Si. The first metal magnetic particles 31 may contain additives other than Si. The first metal magnetic particles 31 may contain, as the additive, at least one element selected from the group of Cr, Al, C, Zr, Nb, Cu, B and P. When the first metal magnetic particles 31 contain Si, the Si content in the first metal magnetic particles 31 may be 1.0 wt % to 3.0 wt %, for example. The soft magnetic metal material for the first metal magnetic particles 31 is, for example, (1) alloys such as Fe—Si, Fe—Si—Cr, Fe—Si—Al, Fe—Si—B—P—Cu; (2) amorphous materials Fe—Si—Cr—B—C or Fe—Si—B—Cr; or (3) a mixture material thereof. The composition of the first metal magnetic particles 31 is not limited to those described above. In at least one embodiment of the present invention, the Fe content in the first metal magnetic particles 31 may be 95 wt % or greater. The source powder from which the first metal magnetic particles 31 with an Fe content of 95 wt % or more is made is soft due to the low Si content and is easily deformed by a compressive force applied during molding. As will be described below, although having an Fe content of 95 wt % or more, the first metal magnetic particles 31 still have a high circularity since their source powder experience little deformation. Therefore, the first metal magnetic particles 31 have no large stress strain left.

In at least one embodiment of the present invention, the base body 10 may include a plurality of second metal magnetic particles (not shown) in addition to the first metal magnetic particles 31. The second metal magnetic particles in the base body 10 may be referred to as a second group of metal magnetic particles. The average particle size of the second metal magnetic particles may be smaller than the average particle size of the first metal magnetic particles 31 (the first average particle size). For example, the particle size of the second metal magnetic particles is 0.75 or less times as large as the first average particle size.

In at least one embodiment of the present invention, the base body 10 may contain a plurality of third metal magnetic particles (not shown) in addition to the first metal magnetic particles 31 and second metal magnetic particles. The third metal magnetic particles contained in the base body 10 may be referred to as a third group of metal magnetic particles. The average particle size of the third metal magnetic particles (the third average particle size) may be smaller than the average particle size of the second metal magnetic particles (the second average particle size). For example, the particle size of the third metal magnetic particles is 0.75 or less times as large as the second average particle size.

In at least one embodiment of the present invention, the base body 10 may contain a plurality of fourth metal magnetic particles (not shown) in addition to the first metal magnetic particles 31, second metal magnetic particles and third metal magnetic particles. The fourth metal magnetic particles in the base body 10 may be referred to as a fourth group of metal magnetic particles. The average particle size of the fourth metal magnetic particles (the fourth average particle size) may be smaller than the average particle size of the third metal magnetic particles (the third average particle size). For example, the particle size of the fourth metal magnetic particles is 0.75 or less times as large as the third average particle size.

The second metal magnetic particles may fill the gaps between the first metal magnetic particles 31, which can allow the base body 10 to achieve enhanced mechanical strength. Likewise, the third metal magnetic particles can fill the gaps between the first metal magnetic particles 31, the gaps between the second metal magnetic particles, and the gaps between the first metal magnetic particles 31 and the second metal magnetic particles, which can allow the base body 10 to have enhanced mechanical strength. Likewise, the fourth metal magnetic particles can fill the gaps between the first metal magnetic particles 31, the gaps between the second metal magnetic particles, the gaps between the third metal magnetic particles, the gaps between (i) the first metal magnetic particles 31 and (ii) the second metal magnetic particles or the third metal magnetic particles, and the gaps between the second metal magnetic particles and the third metal magnetic particles, which can allow the base body 10 to have enhanced mechanical strength.

In at least one embodiment of the present invention, where the total mass of the first, second and third groups of metal magnetic particles is 100 wt %, the third group of metal magnetic particles may account for 0 to 5 wt % in the base body 10.

As used herein, the term “metal magnetic particles” may collectively refer to the first metal magnetic particles 31 and the other metal magnetic particles (the second metal magnetic particles, the third metal magnetic particles, and the fourth metal magnetic particles) for the sake of brevity unless the context requires them to be distinguished from each other.

In at least one embodiment of the present invention, the composition of the first metal magnetic particles 31 may differ from the composition of the second metal magnetic particles. For example, the first metal magnetic particles 31 may contain an element that is not contained in the second metal magnetic particles. For example, while the first metal magnetic particles 31 and second metal magnetic particles both contain Fe and Si, only one of them may contain one element selected from the group of Nb, Cu and Cr. For example, each of the first metal magnetic particles 31 composing the first group of metal magnetic particles may contain Fe, Si, Nb, Cu, B, and C, and each of the second metal magnetic particles composing the second group of metal magnetic particles may contain Fe, Si, Cr, B, and C. In this case, Nb and Cu are contained in the first metal magnetic particles 31 but not in the second metal magnetic particles. In addition, Cr is contained in the second metal magnetic particles, but not in the first metal magnetic particles 31. In other words, in at least one embodiment, the first metal magnetic particles 31 can be distinguished from the second metal magnetic particles based on a difference in elements they contain. The composition of the third metal magnetic particles may be different from the composition of the first metal magnetic particles 31 and from the composition of the second metal magnetic particles. In this case, the third metal magnetic particles can be distinguished from the first metal magnetic particles 31 and from the second metal magnetic particles based on a difference in elements they contain. The composition of the fourth metal magnetic particles may be different from the composition of the first metal magnetic particles 31, from the composition of the second metal magnetic particles, and from the composition of the fourth metal magnetic particles. In this case, the fourth metal magnetic particles can be distinguished from the first metal magnetic particles 31, from the second metal magnetic particles, and from the third metal magnetic particles based on a difference in elements they contain.

In at least one embodiment of the present invention, the first metal magnetic particles 31 may be distinguished from the second metal magnetic particles based on a difference in ratio between the elements they both contain. For example, in at least one embodiment of the present invention, in a case where the first metal magnetic particles 31 and the second metal magnetic particles both contain Si, the Si content may be higher in the first metal magnetic particles 31 than in the second metal magnetic particles. In at least one embodiment of the present invention, the Si content in the first metal magnetic particles 31 is 2 wt % or greater. The Si content in the second metal magnetic particles, which may be lower than that in the first metal magnetic particles 31, ranges from 0.5 wt % to 2.0 wt %, for example. The third metal magnetic particles can be distinguished from the first metal magnetic particles 31 and from the second metal magnetic particles based on a difference in ratio between the elements they contain. The fourth metal magnetic particles can be distinguished from the first metal magnetic particles 31, from the second metal magnetic particles, and from the third metal magnetic particles based on a difference in ratio between the elements they contain.

In at least one embodiment of the present invention, the strength of each of the first metal magnetic particles 31 is higher than that of each of the second metal magnetic particles. For example, the Si content may be higher in the first metal magnetic particles 31 than in the second metal magnetic particles, so that the strength of each of the first metal magnetic particles 31 can be higher than that of each of the second metal magnetic particles. This can reduce deformation of the first metal magnetic particles 31, which are susceptible to the molding pressure when the compression molding is employed to manufacture the base body 10.

As used herein, the term “strength” of the metal magnetic particles may mean deformation strength that may be observed when the metal magnetic particles experience plastic or elastic deformation. The deformation strength of the metal magnetic particles is represented by the strength required to deform the metal magnetic particles by compressing them. The strength of the metal magnetic particles is an indicator of how difficult it is to deform the metal magnetic particles and measured in accordance with JIS Z 8844:2019, for example. The strength of the first metal magnetic particles 31 can be measured using a commercially available compression testing machine (for example, MCT510 available from SHIMADZU CORPORATION). For instance, for each of the first metal magnetic particles 31, the deformation strength to cause compression displacement equal to 10% of the particle size is obtained. An average of the deformation strength values of the particles can be defined as the strength of the first metal magnetic particles 31. The strength of the second, third and fourth metal magnetic particles can be defined in the same manner as the strength of the first metal magnetic particles. The strength of the first metal magnetic particles 31 can be measured in an alternative way. The base body 10 is cut along the T-axis direction to expose a sectional surface, for which Vickers hardness is measured. The measured Vickers hardness can be defined as the strength of the first metal magnetic particles 31. In this case, the Vickers hardness is measured for some of the metal magnetic particles in the base body 10 that have a size of 5 μm or greater. The Vickers hardness can be measured by a commercially available Micro Vickers hardness tester (for example, MMT-X7 available from Matsuzawa Co., Ltd). In at least one embodiment of the present invention, each of the first metal magnetic particles 31 has higher strength than each of the second metal magnetic particles. This means that the first metal magnetic particles 31 are less likely to be deformed than the second metal magnetic particles. The first metal magnetic particles 31 thus experience reduced deformation when compression molding is employed to manufacture the base body 10. The metal magnetic particles can exhibit high strength by having a high Si content. Furthermore, the metal magnetic particles can exhibit high strength if they are made from an amorphous magnetic material. If an amorphous metal magnetic particle is heated, a part is turned into crystalline but the remaining stays amorphous. Such a metal magnetic particle that is partly crystalline also has high strength. In at least one embodiment of the present invention, each of the first metal magnetic particles 31 has a strength of 500 MPa or greater. In at least one embodiment of the present invention, the Vickers hardness of each first metal magnetic particle 31 is 1000 Hv or greater.

The average particle size of the first metal magnetic particles 31 is, for example, 4 μm to 30 μm. As used herein, the first average particle size refers to the average particle size of the first group of metal magnetic particles. The first average particle size is calculated in the following manner, for example. The base body 10 is cut along the T-axis direction to expose a sectional surface. The sectional surface is photographed using a scanning electron microscope (SEM) to obtain an SEM image at a magnification of 2000 to 5000. Then, the particle size distribution (for example, the volume-based particle size distribution) of the first metal magnetic particles 31 is determined based on the SEM image, and the 50th percentile (D50) of the particle size distribution can be used as the average particle size of the first group of metal magnetic particles (the first average particle size).

When the base body 10 contains the second metal magnetic particles, the average particle size of the second metal magnetic particles is less than the average particle size of the first metal magnetic particles 31. The average particle size of the second group of metal magnetic particles may be referred to as a second average particle size. The average particle size of the second metal magnetic particles is, for example, from 0.2 μm to 6 μm. When the base body 10 contains both of the first metal magnetic particles and the second metal magnetic particles, the average particle sizes of the first and second groups of metal magnetic particles are calculated as follows, for example. First, the base body 10 is cut along the T-axis direction to expose a sectional surface. The sectional surface is photographed using a scanning electron microscope (SEM) to obtain an SEM image at a magnification of 2000 to 5000. Then, SEM-EDS mapping is performed within the visual field of the SEM image to distinguish the first metal magnetic particles 31 from the second metal magnetic particles. For example, the first metal magnetic particles 31 have a higher Si content than the second metal magnetic particles. Based on whether the Si content is higher than a prescribed value, the metal magnetic particles contained in the base body 10 can be classified into the first metal magnetic particles 31 and the second metal magnetic particles. Then, the particle size distribution (for example, the volume-based particle size distribution) of the first metal magnetic particles 31 is determined based on the SEM image, and the 50th percentile (D50) of the particle size distribution can be used as the average particle size of the first group of metal magnetic particles (the first average particle size). Similarly, the particle size distribution of the second metal magnetic particles is determined based on the SEM image, and the 50th percentile of the particle size distribution can be used as the average particle size of the second group of metal magnetic particles (the second average particle size). In at least one embodiment of the present invention, the first average particle size is five times or more larger than the second average particle size. According to at least one embodiment of the present invention, the base body 10 contains the first metal magnetic particles 31 having the first average particle size and the second metal magnetic particles having the second average particle size smaller than the first average particle size. Therefore, the second metal magnetic particles get in between the first metal magnetic particles 31. This can increase the filling factor of metal magnetic particles in the base body 10.

When the base body 10 contains the second metal magnetic particles in addition to the first metal magnetic particles 31, the first metal magnetic particles 31 account for a larger proportion in terms of mass than the second metal magnetic particles in the base body 10. In at least one embodiment of the present invention, the ratio in weight of the first group of metal magnetic particles to the second group of metal magnetic particles in the base body 10 is within the range of 60:40 to 80:20. Specifically, where the total mass of the first and second groups of metal magnetic particles in the base body 10 is defined as 100 wt %, the first group of metal magnetic particles in the base body 10 accounts for 60 to 80 wt %, and the second group of metal magnetic particles in the base body 10 accounts for 20 to 40 wt %. In other words, the first group of metal magnetic particles accounts for a larger proportion in terms of weight than the second group of metal magnetic particles in the base body 10. Since the first metal magnetic particles 31 of a large diameter account for a large proportion in terms of mass in the base body, the base body 10 can achieve increased magnetic permeability.

In at least one embodiment of the present invention, the base body 10 may contain alumina particles, silica particles or a mixture thereof. Since the base body 10 contains alumina particles, silica particles or a mixture thereof, the base body 10 can have a lower coefficient of linear expansion and higher mechanism strength.

In at least one embodiment of the present invention, a first average circularity representing an average circularity of the first metal magnetic particles 31 is greater than 0.8. A first average circularity of 0.8 or greater can be achieved by applying a low molding pressure of 100 MPa or less to the source material containing the magnetic powder from which the first metal magnetic particles 31 are made during the manufacturing process of the base body 10. How to manufacture the base body 10 will be described below in detail. In the base body 10, the first average circularity of the first metal magnetic particles 31 is greater than 0.8. This means that the first metal magnetic particles 31 experience reduced stress strain, thereby reducing a drop in magnetic permeability of the base body 10 that may be caused by an increase in stress strain.

When the base body 10 contains the second metal magnetic particles in addition to the first metal magnetic particles 31, the average circularity of the second metal magnetic particles in the base body 10 or the second average circularity may be higher than the average circularity of the first metal magnetic particles 31 in the base body 10. When compression molding is employed to manufacture the base body 10 containing the second metal magnetic particles in addition to the first metal magnetic particles 31, the first metal magnetic particles 31, which have a larger diameter, are more susceptible to the compressive strain. Therefore, during the manufacturing of the base body 10, the first metal magnetic particles 31 are more likely to experience significant strain. Here, as for the metal magnetic particles, the higher the Si content is, the higher the Young's module is. For this reason, the first metal magnetic particles 31 can be saved from experiencing significant strain if the Si content is controlled to be greater in the first metal magnetic particles than in the second metal magnetic particles.

The second metal magnetic particles can be also saved from experiencing strain if the second average circularity of the second metal magnetic particles is higher than the first average circularity. If the second metal magnetic particles are made from a magnetic powder having a higher circularity than the magnetic powder from which the first metal magnetic particles 31 are made, the strain left in the source powder for the second metal magnetic particles can be less than the strain left in the source powder from which the first metal magnetic powders 31 are made. Due to the small diameter, the magnetic powder from which the second metal magnetic particles are made is less susceptible to the molding pressure than is the magnetic powder from which the first metal magnetic particles 31 are made during the compression step of the process of manufacturing the base body 10. Therefore, the compression molding is less likely to cause strain in the second metal magnetic particles (or its source powder). As described above, although the Si content is lower in the second metal magnetic particles than in the first metal magnetic particles 31, the second metal magnetic particles are still saved from experiencing strain.

The Si content can be lower in the second metal magnetic particles than in the first metal magnetic particles 31. In this case, the main component (Fe or Ni) of the second metal magnetic particles accounts for a larger proportion than Fe does in the first metal magnetic particles 31. As a result, containing the second metal magnetic particles, the base body 10 can achieve improved magnetic permeability while reducing the core loss, which is caused by the strain remaining in the metal magnetic particles.

As the circularity of the metal magnetic particles increases, the surface area of the metal magnetic particles drops. When the second average circularity of the second group of metal magnetic particles is higher than the first average circularity of the first group of metal magnetic particles, the second metal magnetic particles can have a smaller surface area. This can contribute to reduce aggregation of the second metal magnetic particles. If the second metal magnetic particles aggregate, the gaps between the first metal magnetic particles 31 are not filled with a sufficient number of second metal magnetic particles. This will result in a lower filling factor of the metal magnetic particles in the base body 10. Accordingly, the second average circularity of the second group of metal magnetic particles is higher than the first average circularity of the first group of metal magnetic particles, so that the second metal magnetic particles have a smaller surface area and are thus prevent from aggregating. The aggregation of the second metal magnetic particles may cause a drop in filling factor of the metal magnetic particles in the base body 10, but the present embodiment can prevent such a drop.

The average circularity of the first metal magnetic particles 31 in the base body 10 can be calculated as follows. In the same manner as when the average particle size is calculated, the base body 10 is cut along the T-axis (along the coil axis Ax) to expose a sectional surface. The sectional surface is photographed using a scanning electron microscope (SEM) to obtain an SEM image at a magnification of 500 to 10000. Then, the circularity of each first metal magnetic particle 31 included in the SEM image is calculated using a commercially available image processing software (for example, Mac-View available from Mountech Co., Ltd.), and the average of the calculated circularity values is defined as the first average circularity.

When the base body 10 contains both of the first metal magnetic particles 31 and the second metal magnetic particles, the average circularity of the second metal magnetic particles (second average circularity) is calculated as follows, for example. First, the base body 10 is cut along the T-axis direction to expose a sectional surface. The sectional surface is photographed using a scanning electron microscope (SEM) to obtain an SEM image at a magnification of 500 to 10000. Then, SEM-EDS mapping is performed within the visual field of the SEM image to distinguish the first metal magnetic particles 31 from the second metal magnetic particles. As described above, based on whether the content of a specific element (for example, Si) is higher than a prescribed value, the metal magnetic particles in the base body 10 can be classified into the first metal magnetic particles 31 and the second metal magnetic particles. After this, the circularity of each second metal magnetic particle in the SEM image is calculated, and the average of the calculated circularity values is defined as the second average circularity. The magnification to obtain the SEM image depends on the particle size of the first metal magnetic particles 31 and/or the second metal magnetic particles under observation.

The magnification in capturing the SEM image used to calculate the circularity can be determined according to the particle size of the metal magnetic particles under measurement. For example, when the particle size is from 1 μm to 30 μm, the magnification is 2000×. When the particle size is less than 1 μm, the magnification is about 10000×. When the particle size is greater than 30 μm, the magnification is about 500×. Since the magnification is adjusted considering the particle size of the metal magnetic particles to be measured, the metal magnetic particles can always have equalized particle sizes in the observed region.

In at least one embodiment of the present invention, the first average circularity of the first metal magnetic particles 31 in the base body 10 is greater than 0.8. Therefore, each of the first metal magnetic particles 31 in the section of the base body 10 generally has a less complex shape (i.e., a shape similar to a circle) as shown in FIG. 3. In comparison with the embodiment of the present invention, FIG. 4 shows an example of a section of a base body of a conventional coil component. For the conventional coil component, the metal magnetic particles are compressed with a relatively high molding pressure of approximately from 400 MPa to 800 MPa. Since the compression molding deforms the metal magnetic particles, the metal magnetic particles 51 in the base body of the conventional coil component have a complex shape as shown in FIG. 4. Comparing FIGS. 3 and 4 reveals that, while at least some of the metal magnetic particles 51 in the conventional coil component have depressions, the first metal magnetic particles 31 relating to the embodiment of the present invention have an outer periphery free of depressions. Such depressions can be identified in the photograph shown in FIG. 1 of the '655 Publication.

When the base body 10 contains the first metal magnetic particles 31 and the second metal magnetic particles, the second average circularity of the second metal magnetic particles is higher than the average circularity of the first metal magnetic particles 31. When the base body 10 contains the first metal magnetic particles 31, the second metal magnetic particles and the third metal magnetic particles, the third average circularity of the third metal magnetic particles is higher than the second average circularity of the second metal magnetic particles. When the base body 10 contains the first metal magnetic particles 31, the second metal magnetic particles, the third metal magnetic particles and the fourth metal magnetic particles, the fourth average circularity of the fourth metal magnetic particles is higher than the third average circularity of the third metal magnetic particles. The second average circularity is, for example, 0.85 or higher. The third average circularity is, for example, 0.89 or higher. The fourth average circularity is, for example, 0.92 or higher.

In at least one embodiment of the present invention, the source powder for the metal magnetic particles in the base body 10 (for example, the first metal magnetic particles 31) may be made using atomization. The source powder for the metal magnetic particles in the base body 10 can be produced using, in addition to atomization, various vapor-phase, liquid-phase, or solid-phase techniques. As for the vapor-phase techniques, a source gas is heated by a heating source such as a laser and an arc, to condense the monomers in the source gas into nano particles. The vapor-phase techniques include CVD, vapor-phase synthesis, and evaporation and condensation. The magnetic powder from which the metal magnetic particles in the base body 10 are made are more preferably produced by the build-up method than by the break-down method, where the former produces powder by growing or aggregating molecular source materials using the vapor-, liquid- or solid-phase methods and the latter produces powder by pulverizing agglomerates. This is because magnetic powders produced by the break-down method are more likely to have large stress strain than magnetic powders produced by the build-up method.

As described above, the base body 10 may have the core area 10X and the margin area 10Y. The first average circularity in the core area 10X may differ from the first average circularity in the margin area 10Y. For example, the first average circularity in the core area 10X may be higher than the first average circularity in the margin area 10Y. Since the first average circularity in the core area 10X, which exhibits a high magnetic flux density when a current flows through the coil conductor 25, is higher than the first average circularity in the margin area 10Y, the base body 10 can have further improved magnetic permeability. Likewise, in at least one embodiment of the present invention, the second average circularity in the core area 10X may be higher than the second average circularity in the margin area 10Y.

In a case where the first average circularity in the core area 10X differs from the first average circularity in the margin area 10Y, the difference between the two is equal to or less than 5% of the first average circularity in the core area 10X. The first metal magnetic particles 31 can be uniformly distributed in the base body 10 if the difference between the first average circularity in the core area 10X and the first average circularity in the margin area 10Y in the base body 10 is controlled to fall within a prescribed range (for example, equal to or less than 5% of the first average circularity in the core area 10X). The uniform distribution of the first metal magnetic particles 31 in the base body 10 can contribute to prevent the magnetic fluxes from being localized in some areas in the base body 10 when a current flows through the coil conductor 25. The uniform distribution of the first metal magnetic particles 31 in the base body 10 can also result in a higher filling factor of the metal magnetic particles in the base body 10.

As described above, the third average circularity may be higher than the second average circularity. When the third average circularity is higher than the second average circularity, the third metal magnetic particles have a small surface area and are thus prevented from aggregating. The aggregation of the third metal magnetic particles may cause a drop in filling factor, but the present embodiment can prevent such a drop. The base body 10 can achieve improved filling factor of the metal magnetic particles. Due to the improved filling factor, the base body 10 can achieve enhanced magnetic permeability.

The Si content may be lower in the third metal magnetic particles than in the first metal magnetic particles 31. The third metal magnetic particles may be free of Si. The Fe content may be higher in the third metal magnetic particles than in the first metal magnetic particles 31. If any strain remains in the metal magnetic particles, the strain may cause core loss. Since the base body 10 contains the third metal magnetic particles, the base body 10 can accomplish reduced core loss while achieving improved magnetic permeability due to the increased filling factor.

The Si content may be lower in the fourth metal magnetic particles than in the first metal magnetic particles 31. The fourth metal magnetic particles may be free of Si. The Fe content may be higher in the fourth metal magnetic particles than in the first metal magnetic particles 31. If any strain remains in the metal magnetic particles, the strain may cause core loss. Since the base body 10 contains the fourth metal magnetic particles, the base body 10 can accomplish reduced core loss while achieving improved magnetic permeability due to the increased filling factor.

Adjacent ones of the metal magnetic particles in the base body 10 may be bound together via an insulating film. The insulating film may include oxide of a constituent element of the metal magnetic particles or may be made of an insulating material other than the constituent element of the metal magnetic particles.

The base body 10 may contain a resin. The base body 10 may include a resin binder 36 that binds the metal magnetic particles, as shown in FIG. 3. The binder 36 is, for example, a highly insulating thermosetting resin. The resin material used for the binder 36 may be an epoxy resin, a polyimide resin, a polystyrene (PS) resin, a high-density polyethylene (HDPE) resin, a polyoxymethylene (POM) resin, a polycarbonate (PC) resin, a polyvinylidene fluoride (PVDF) resin, a phenolic resin, a polytetrafluoroethylene (PTFE) resin, or a polybenzoxazole (PBO) resin. In at least one embodiment of the present invention, where the total mass of the metal magnetic particles in the base body 10 is 100 wt %, the resin content in the base body 10 is from 1 to 10 wt %.

The following now describes an example method of manufacturing the coil component 1 relating to the embodiment of the present invention. The following example method of manufacturing the coil component 1 employs compression molding. The method of manufacturing the coil component 1 using compression molding includes: a preparation step of mixing and kneading metal magnetic particles and a resin to produce a resin mixture composition, a compression molding step of compressing and molding the resin mixture composition into a molded body, and a thermal treatment step of heating the molded body, which results from the compression molding step, into a base body.

In the preparation step, a first magnetic powder, from which the first metal magnetic particles 31 are obtained, a resin and a diluting solvent are mixed and kneaded to produce a resin mixture composition. In a case where the base body contains the second metal magnetic particles, the resin mixture composition includes a powder mixture of the first magnetic powder and a second magnetic powder from which the second metal magnetic particles are made. Similarly, in a case where the base body also includes the third metal magnetic particles, the resin mixture composition includes a powder mixture including the first magnetic powder, the second magnetic powder and a third magnetic powder from which the third metal magnetic particles are made. In a case where the base body also contains the fourth metal magnetic particles, the resin mixture composition includes a powder mixture of the first magnetic powder, the second magnetic powder, the third magnetic powder and a fourth magnetic powder from which the fourth metal magnetic particles are made. In at least one embodiment of the present invention, the source material of the metal magnetic particles, specifically, the first, second, third and fourth magnetic powders in the resin mixture composition are in the form of particles having an average circularity of 0.9 or greater. The first metal magnetic particles 31, the second metal magnetic particles, the third metal magnetic particles and the fourth metal magnetic particles may have a reduced average circularity since their source material is subject to deformation under the compressive force applied during the subsequent compression molding step, but the source material may have an average circularity of 0.9 or greater during the preparation step.

In the following compression molding step, the coil conductor 25, which is prepared in advance, is placed in a cavity of a mold, the resin mixture composition produced in the above-described manner is poured into the cavity of the mold having the coil conductor 25 therein, and the resin mixture composition in the cavity of the mold is subject to compression under an adequate molding pressure while being heated. In this manner, the molded body enclosing therein the coil conductor 25 is produced. In at least one embodiment of the present invention, the adequate molding pressure is 100 MPa or less. If the molding pressure is too high, the metal magnetic particles tend to be deformed, as a result of which their circularity is compromised. In an embodiment of the present invention, the molding pressure applied for fabricating the molded body may be 50 MPa or less, 40 MPa or less, or 30 MPa or less. If the molding pressure is too low, the molded body suffers from a low filling factor of the metal magnetic particles. Therefore, a lower limit may be set for the molding pressure. In an embodiment of the present invention, the lower limit of the molding pressure applied for fabricating the molded body may be 5 MPa.

The molding pressure may depend on the ratio of the resin in the resin mixture composition. For example, when the resin content in the resin mixture composition is 3 wt % or more, the resin mixture composition is compressed at a molding pressure of 50 to 100 MPa. When the resin content in the resin mixture composition is lower than 3 wt %, the resin mixture composition is compressed at a molding pressure of 5 to 50 MPa. As noted, the higher the resin content is in the resin mixture composition, the higher the molding pressure is. When the resin content is high in the resin mixture composition, the magnetic powder is less susceptible to the molding pressure. Accordingly, a high molding pressure applied to the resin mixture composition does not excessively deform the magnetic powder. For example, the difference between a first source material average circularity, which represents the average circularity of the first magnetic powder, and the first average circularity of the first metal magnetic particles 31 obtained by applying pressure to the first magnetic powder is equal to or less than 10% of the first source material average circularity. The difference between the first source material average circularity of the first magnetic powder and the first average circularity of the first metal magnetic particles 31 may be equal to or less than 5% of the first source material average circularity, or 3% of it.

The difference between the first source material average circularity of the first magnetic powder and the first average circularity of the first metal magnetic particles 31 may be controlled to be 10% or less. This means that the compressing step only causes reduced strain in the first metal magnetic particles 31. The difference between the first source material average circularity of the first magnetic powder and the first average circularity of the first metal magnetic particles 31 may be controlled to be 5% or less. This means that the first metal magnetic particles 31 can be more effectively saved from experiencing strain. The difference between the first source material average circularity of the first magnetic powder and the first average circularity of the first metal magnetic particles 31 may be controlled to be 3% or less. This means that the first metal magnetic particles 31 can be further more effectively saved from experiencing strain.

In at least one embodiment of the present invention, when the base body 10 contains the first metal magnetic particles 31 and the second metal magnetic particles, the difference between a second source material average circularity, which represents the average circularity of the second magnetic powder from which the second metal magnetic particles are made, and the second average circularity of the second metal magnetic particles obtained by applying pressure to the second magnetic powder is equal to or less than 10% of the second source material average circularity. The difference between the second source material average circularity of the second magnetic powder and the second average circularity of the second metal magnetic particles may be equal to or less than 5% of the second source material average circularity, or 3% of it.

In at least one embodiment of the present invention, when the base body 10 additionally contains the third metal magnetic particles, the difference between a third source material average circularity, which represents the average circularity of the third magnetic powder from which the third metal magnetic particles are made, and the third average circularity of the third metal magnetic particles obtained by applying pressure to the third magnetic powder is equal to or less than 10% of the third source material average circularity. The difference between the third source material average circularity of the third magnetic powder and the third average circularity of the third metal magnetic particles may be equal to or less than 5% of the third source material average circularity, or 3% of it.

In at least one embodiment of the present invention, when the base body 10 additionally contains the fourth metal magnetic particles, the difference between a fourth source material average circularity, which represents the average circularity of the fourth magnetic powder from which the fourth metal magnetic particles are made, and the fourth average circularity of the fourth metal magnetic particles, which are obtained by applying pressure to the fourth magnetic powder, is equal to or less than 10% of the fourth source material average circularity. The difference between the fourth source material average circularity of the fourth magnetic powder and the fourth average circularity of the fourth metal magnetic particles may be equal to or less than 5% of the fourth source material average circularity, or 3% of it.

In the compression molding step, the first magnetic powder is compressed into the first metal magnetic particles 31, and the second magnetic powder is compressed into the second metal magnetic particles. When the resin mixture composition includes the third magnetic powder, the compression molding step compresses the third magnetic powder into the third metal magnetic particles. When the resin mixture composition includes the fourth magnetic powder, the compression molding step compresses the fourth magnetic powder into the fourth metal magnetic particles.

After the molded body is obtained through the compression molding step, the manufacturing method proceeds to the thermal treatment step. In the thermal treatment step, the molded body obtained in the compression molding step is thermally treated, as a result of which the base body 10 having the coil conductor 25 therein can be obtained. The thermal treatment cures the resin in the resin mixture composition into a binder, and the binder binds together the metal magnetic particles. The heating in the thermal treatment step is performed at a temperature equal to or higher than the cure temperature of the resin included in the resin mixture composition. The heating in the thermal treatment step is performed at a temperature of, for example, from 100° C. to 200° C. for a duration of 30 minutes to 240 minutes. The heating in the thermal treatment step is performed at a temperature of 200° C. or lower. The above-described process of forming the base body 10 uses a low molding pressure in the range of 5 to 100 MPa. The magnetic powders included in the resin mixture composition are not subject to a high molding pressure, and this can prevent stress strain from occurring in the metal magnetic particles (for example, the first metal magnetic particles 31) in the base body 10. In addition, since the magnetic powders in the resin mixture composition have an increased average circularity, only a reduced frictional force may act on the magnetic powders in the resin mixture composition while the resin mixture composition is compressed. This means that the magnetic powders are highly flowable in the resin mixture composition during the compression molding step. Accordingly, the magnetic powders are likely to have a structure similar to the close-packing structure in the mold. A low molding pressure may cause a drop in filling factor of the metal magnetic particles in the base body 10. As described above, however, the present embodiment can prevent such a drop since the magnetic powders originally have a high average circularity and keep the high average circularity since the compression molding step uses a low molding pressure (1100 MPa or less).

Next, a conductor paste is applied to both ends of the base body 10 obtained in the above-described manner to form the external electrodes 21 and 22. The external electrode 21 is electrically connected to one of the ends of the coil conductor 25 placed within the base body 10, and the external electrode 22 is electrically connected to the other end of the coil conductor 25 placed within the base body 10. The external electrodes 21 and 22 may include a plated layer. There may be two or more plated layers. The two plated layers may include an Ni plated layer and an Sn plated layer externally provided on the Ni plated layer. In the above-described manner, the coil component 1 is completed.

The manufactured coil component 1 may be mounted on the mounting substrate 2a using a reflow process. Specifically, the mounting substrate 2a having the coil component 1 thereon passes at a high speed through a reflow furnace heated to, for example, a peak temperature of 260° C., and the external electrodes 21, 22 are then soldered to the corresponding lands 3 of the mounting substrate 2a. In this way, the coil component 1 is mounted on the mounting substrate 2a, and thus the circuit board 2 is manufactured.

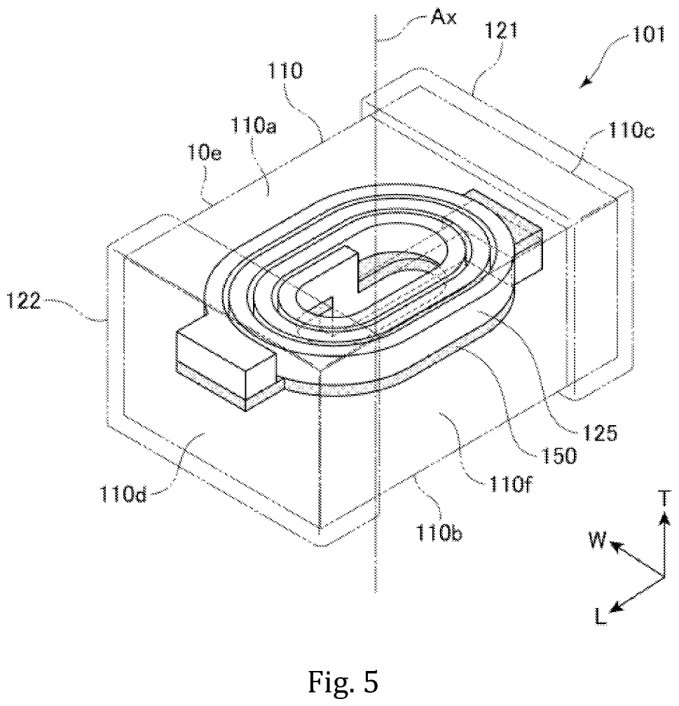

Next, a coil component 101 according to another embodiment of the present invention will be described with reference to FIG. 5. The coil component 101 is a planar coil. As shown, the coil component 101 includes a base body 110, an insulating plate 150 disposed in the base body 110, a coil conductor 125 disposed in the base body 110 on a top surface of the insulating plate 150, an external electrode 121 disposed on the base body 110, and an external electrode 122 disposed on the base body 110 and spaced apart from the external electrode 121. The base body 110 is formed of a magnetic material similarly to the base body 10. The insulating plate 150 is made of an insulating material and shaped like a plate.

The base body 110 is formed of a magnetic material containing metal magnetic particles, similarly to the base body 10. The base body 110 in one embodiment contains a plurality of first metal magnetic particles 31. In the base body 110, a first average circularity, which represents the average circularity of the first metal magnetic particles 31, is also greater than 0.8. The base body 110 is formed in a substantially rectangular parallelepiped shape. The base body 110 may contain second metal magnetic particles. The base body 110 may contain second and third metal magnetic particles. The base body 110 may contain second, third and fourth metal magnetic particles. The description on the base body 10 applies to the base body 110 wherever possible.

In the illustrated embodiment, the coil conductor 125 has, on the top surface of the insulating plate 150, a wound portion wound spirally around a coil axis Ax extending in the thickness direction (the T-axis direction). The coil conductor 125 is connected at one end thereof to the external electrode 121 and is connected at the other end thereof to the external electrode 122. The coil conductor 125 may have a shape other than the illustrated one. For example, the coil conductor 125 may have, on the top and bottom surfaces of the insulating plate 150, wound portions wound spirally around the coil axis Ax. In this case, the coil conductor 125 has a connection portion to connect between the wound portion on the top surface of the insulating plate 150 and the wound portion disposed on the bottom surface of the insulating plate 150. The coil conductor 125 may have any shape other than the ones described herein, unless inconsistency arises.

The following describes an example method of manufacturing the coil component 101. To start with, the insulating plate 150 made of a magnetic material and shaped like a plate is prepared. Next, a photoresist is applied to each of the top and bottom surfaces of the insulating plate 150, a conductor pattern is exposed and transferred to each of the top and bottom surfaces of the insulating plate 150, and the photoresist is then developed. In this manner, a resist having an opening pattern for forming the coil conductor 125 is formed on each of the top and bottom surfaces of the insulating plate 150.

Next, plating is performed, so that a conductive metal fills the gaps defined by the opening pattern. Then, etching is performed to remove the resist from the insulating plate 150. As a result, the coil conductor 125 is formed on each of the top and bottom surfaces of the insulating plate 150. A through-hole formed in the insulating plate 150 is filled with a conductive metal to form a via connecting the front and rear portions of the coil conductor 125 on the top and bottom surfaces of the insulating plate 150.

Next, the base body 110 is formed on both of the sides of the insulating plate 150 having the coil conductor 125 formed thereon. To form the base body 110, a compression molding step is performed. In the compression molding step, a first magnetic powder, from which the first metal magnetic particles 31 are made, a resin and a diluting solvent are mixed and kneaded to produce a resin mixture composition. Subsequently, the resin mixture composition is applied in the form of a sheet onto a base material such as a PET film, and the applied resin mixture composition is dried to volatilize the diluting solvent. In this way, a molded body shaped like a sheet is fabricated, which contains the resin and the first metal magnetic particles 31 dispersed in the resin. This sheet-shaped resin molded body will be referred to as a magnetic body sheet. Two magnetic body sheets are prepared, and the above-described coil conductor 125 is placed between the two magnetic body sheets, which is heated and compressed with a pressure from 5 to 100 MPa. As a result, a compressed molded body (a laminate body) having the coil conductor therein is fabricated.

The manufacturing method of the coil component 101 then proceeds to a thermal treatment step. In the thermal treatment step, the above-described laminate body is thermally treated. As a result, the base body 110 having the coil conductor 125 therein can be obtained. The thermal treatment cures the resin in the resin mixture composition into a binder, and the binder binds together the metal magnetic particles. The thermal treatment in the thermal treatment step is performed at a temperature equal to or higher than the cure temperature of the resin contained in the resin mixture composition. The thermal treatment in the thermal treatment step is performed at a temperature of, for example, from 100° C. to 200° C. for a duration of 30 minutes to 240 minutes.

The laminate body, which is mentioned in relation to the above-described manufacturing process, can be fabricated in an alternative manner, as described in the following. In the alternative fabrication method of the laminate body, the insulating plate 150 having the coil conductor 125 formed thereon is placed in a cavity of a mold, and a resin mixture composition is poured into the cavity of the mold. The resin mixture composition is obtained by mixing and kneading together a first magnetic powder, a resin, and a diluting solvent. The resin composition mixture in the mold is compressed at a molding pressure from 5 to 100 MPa while being heated. As a result, a molded body having the coil conductor 125 therein is fabricated. The molded body is subjected to the above-described thermal treatment. As a result, the base body 110 having the coil conductor 125 therein can be obtained.

Next, a conductor paste is applied to the respective ends of the base body 110 obtained in the above-described manner to form the external electrodes 121 and 122. The external electrode 121 is electrically connected to one end of the coil conductor 125 placed within the base body 110, and the external electrode 122 is electrically connected to the other end of the coil conductor 125 placed within the base body 110. In the above-described manner, the coil component 101 is completed.

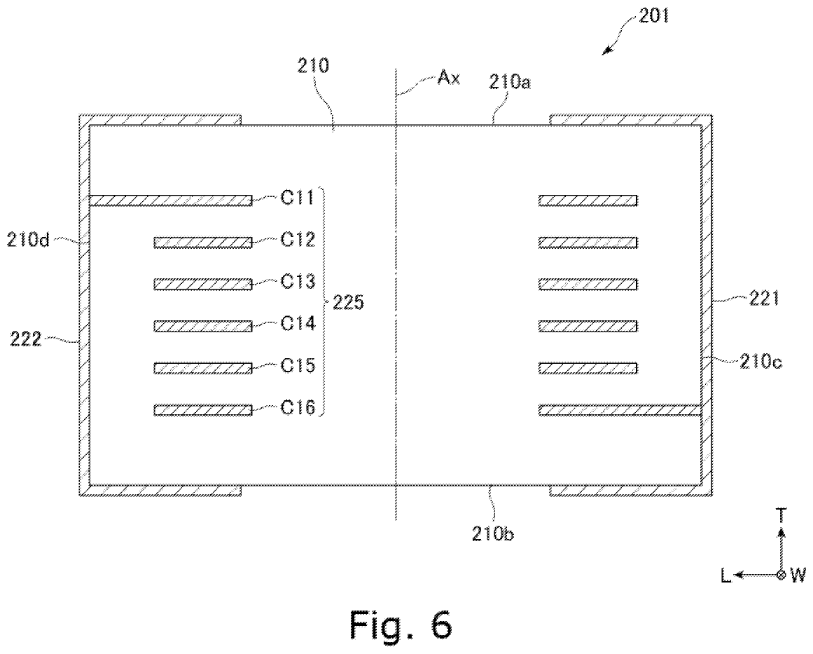

The following describes a coil component 201 relating to another embodiment of the present invention with reference to FIG. 6. The coil component 201 is a laminated coil. As shown, the coil component 201 includes a base body 210, a coil conductor 225 disposed in the base body 210, an external electrode 221 disposed on the base body 210, and an external electrode 222 disposed on the base body 210 at a position spaced apart from the external electrode 221. The base body 210 is formed of a magnetic material, similarly to the base body 10.

The base body 210 is formed of a magnetic material containing a plurality of metal magnetic particles, similarly to the base body 10. In at least one embodiment of the present invention, the base body 210 includes a plurality of first metal magnetic particles 31. In the base body 210, a first average circularity, which represents the average circularity of the first metal magnetic particles 31, is also greater than 0.8. The base body 210 may contain second metal magnetic particles. The base body 210 may contain second and third metal magnetic particles. The base body 210 may contain second, third and fourth metal magnetic particles. The base body 210 is formed in a substantially rectangular parallelepiped shape. The description on the base body 10 applies to the base body 210 wherever possible.

The coil conductor 225 is wound spirally around a coil axis Ax extending in the thickness direction (the T-axis direction). The coil conductor 225 includes conductor patterns C11 to C16 and via conductors (not shown) connecting between adjacent ones of the conductor patterns C11 to C16. The via conductors extend substantially along the coil axis Ax. The conductor patterns C11 to C16 are formed by, for example, printing a conductive paste composed of a highly conductive metal or alloy on a sheet-shaped compressed molded body by screen printing. The conductive paste may be made of Ag, Pd, Cu, Al, or an alloy of these elements. Each of the conductor patterns C11 to C16 is electrically connected to an adjacent one of the conductor patterns via the via conductor. The conductor patterns C11 to C16 thus connected form the spiral coil conductor 225.

The following describes an example method of manufacturing the coil component 201. The coil component 201 can be manufactured by, for example, a lamination process. An example is hereinafter described of the manufacturing method of the coil component 201 using the lamination process.

The first step is to prepare a plurality of magnetic sheets made of a magnetic material. Each of the magnetic sheets can be produced as follows. A first magnetic powder, a binder, which is a thermally decomposable resin (for example, polyvinyl butyral (PVB) resin) and a diluting solvent are mixed and kneaded to produce a resin mixture composition. The resin mixture composition is applied in the form of a sheet onto a base material such as a PET film, and the applied resin mixture composition is dried to evaporate the diluting solvent. This in turn makes a magnetic sheet made of the resin and having the first magnetic powder, from which the first metal magnetic particles 31 are made, dispersed in the resin. The magnetic sheet thus fabricated is placed in a mold and compressed at a pressure of 5 to 100 MPa while being heated. As a result, a sheet-shaped compression-molded body is fabricated. The compression compresses the first magnetic powder into the first metal magnetic particles 31.

Next, a coil conductor is provided on the sheet-shaped compression-molded body in the following manner. To start with, a through hole is formed in the sheet-shaped compression-molded body at a predetermined position so as to penetrate through the sheet-shaped compression-molded body in the T-axis direction. Following this, a conductive paste is printed using screen printing onto the top surface of each sheet-shaped compression-molded body, so that an unsintered conductor pattern is formed on each compression-molded body and the through hole formed in each compression-molded body is filled with the conductive paste.

Next, the compression-molded bodies are stacked to obtain a coil laminated body. The compression-molded bodies are stacked such that the unsintered conductor patterns corresponding to the conductor patterns C11 to C16 and formed on the respective magnetic sheets are each electrically connected to the adjacent unsintered conductor patterns through the unsintered vias.

Following this, a plurality of sheet-shaped compression-molded bodies are stacked to form a top laminated body, which is to be used as the top cover layer. Similarly, a plurality of sheet-shaped compression-molded bodies are stacked to form a bottom laminated body, which is to be used as the bottom cover layer. Next, the bottom laminated body, the coil laminated body, and the top laminated body are stacked in the stated order in the direction of the T axis from the negative side to the positive side, and these stacked laminated bodies are bonded together by thermal compression using a pressing machine to make a main laminated body. Instead of forming the bottom, coil and top laminated bodies, the main laminated body may be made by sequentially stacking all of the sheet-shaped compression-molded bodies prepared in advance and bonding the stacked compression-molded bodies collectively by thermal compression.

Next, the main laminated body is segmented to a desired size by using a cutter such as a dicing machine or a laser processing machine to make a chip laminate. Next, the chip laminate is subjected to a heat treatment. The heat treatment is performed at a temperature of, for example, from 100° C. to 200° C. for a duration of 30 minutes to 240 minutes. The end portions of the chip laminate may be polished by barrel-polishing or the like as necessary.

Next, a conductive paste is applied to both end portions of the chip laminate to form the external electrodes 221 and 222. The coil component 201 is obtained in the above-described manner.

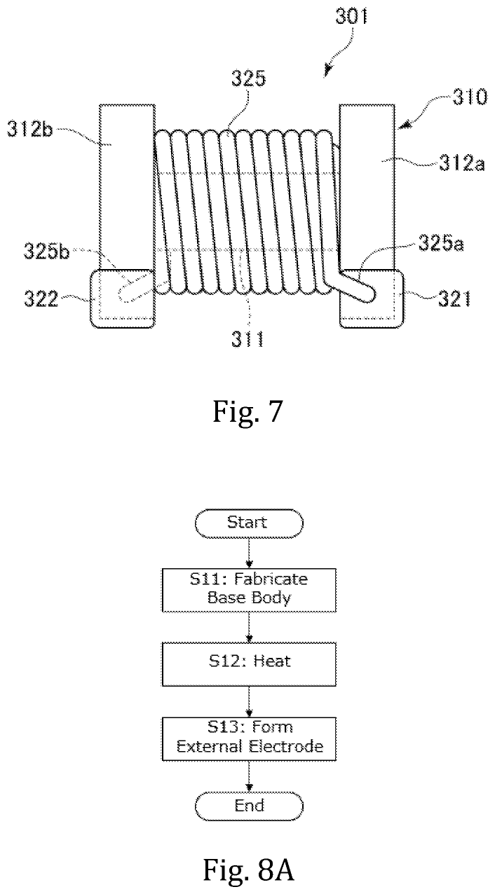

The following describes a coil component 301 relating to another embodiment of the present invention with reference to FIG. 7. The coil component 301 relating to one embodiment of the present invention is a winding inductor. As shown, the coil component 301 includes a base body 310, a coil conductor 325 (winding coil 325), a first external electrode 321, and a second external electrode 322. The base body 310 includes a winding core 311, a flange 312a having a rectangular parallelepiped shape and disposed on one end of the winding core 311, and a flange 312b having a rectangular parallelepiped shape and disposed on the other end of the winding core 311. The coil conductor 325 is wound on the winding core 311. The coil conductor 325 includes a conductive line made of a highly conductive metal material and an insulating coating covering and surrounding the conductive line. The first external electrode 321 extends along the bottom surface of the flange 312a, and the second external electrode 322 extends along the bottom surface of the flange 312b.

The base body 310 is formed of a magnetic material containing a plurality of metal magnetic particles, similarly to the base body 10. The base body 310 in one embodiment contains a plurality of first metal magnetic particles 31. In the base body 310, a first average circularity representing the average circularity of the first metal magnetic particles 31 is also greater than 0.8. The base body 310 may contain second metal magnetic particles. The base body 310 may contain second and third metal magnetic particles. The base body 310 may contain second, third and fourth metal magnetic particles. The description on the base body 10 applies to the base body 310 wherever possible.

The following describes an example method of manufacturing the coil component 301. First, the base body 310 is fabricated. The manufacturing method of the base body 310 includes a preparation step of preparing a resin mixture composition and a compression molding step of compressing and molding the resin mixture composition. In the preparation step, a first magnetic powder, a resin and a diluting solvent are mixed and kneaded to produce a resin mixture composition. The resin mixture composition contains metal magnetic particles dispersed therein. The resin mixture composition is poured in a cavity of a mold, and the resin mixture composition in the cavity of the mold is compressed at a molding pressure of 5 to 100 MPa while being heated. As a result, a molded body is fabricated. The compression compresses the first magnetic powder into the first metal magnetic particles 31.

The molded body obtained by the above-described compression molding step is subjected to a thermal treatment step in which thermal treatment is performed. The thermal treatment step produces the base body 310. The thermal treatment cures the resin in the resin mixture composition into a binder, and the binder binds together the metal magnetic particles. The thermal treatment is performed at a temperature, for example, of from 100° C. to 200° C. for a duration of 30 minutes to 240 minutes.

Next, a coil mounting step is performed where the coil conductor 325 is mounted in the base body 310 resulting from the above-described thermal treatment step. In the coil mounting step, the coil conductor 325 is wound around the base body 310, one end of the coil conductor 325 is connected to the first external electrode 321, and the other end is connected to the second external electrode 322. The coil component 301 can be produced in the above-described manner.

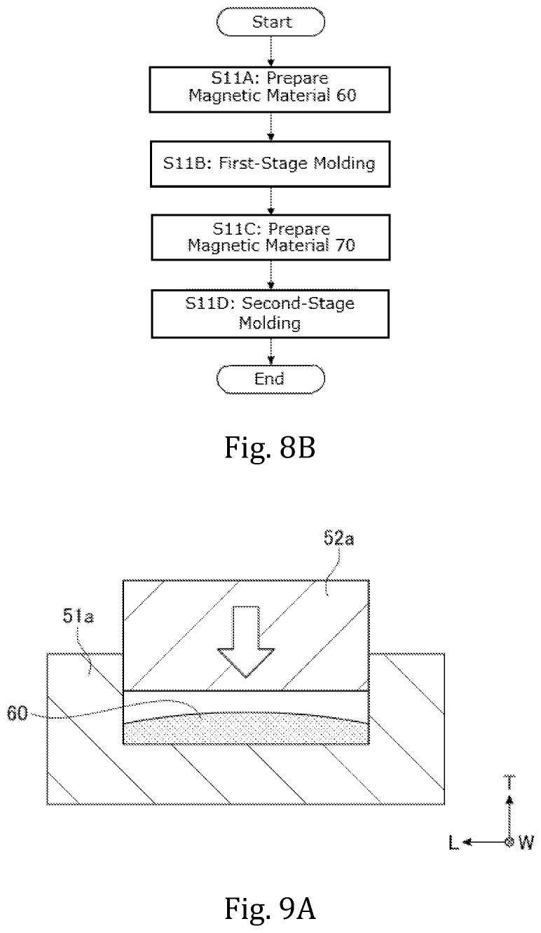

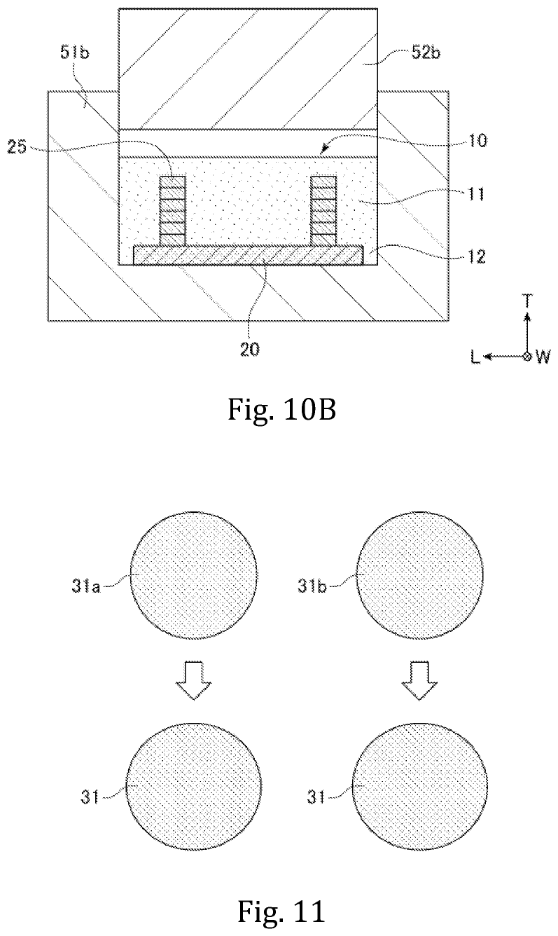

The following now describes another method of manufacturing the coil component 1 with reference to FIGS. 8A and 8B. In a step S11, the base body 10 is fabricated that has the coil conductor 25 provided therein. As shown in FIG. 10B, the base body 10 resulting from this method includes a main body portion 11, a protruding portion 12 protruding downward (toward the negative side along the T-axis) from the main body portion 11 and a plate-shaped core 20 provided below the main body portion 11 and radially inside the protruding portion 12. In FIGS. 1 and 2, the plate-shaped core 20 is not shown.

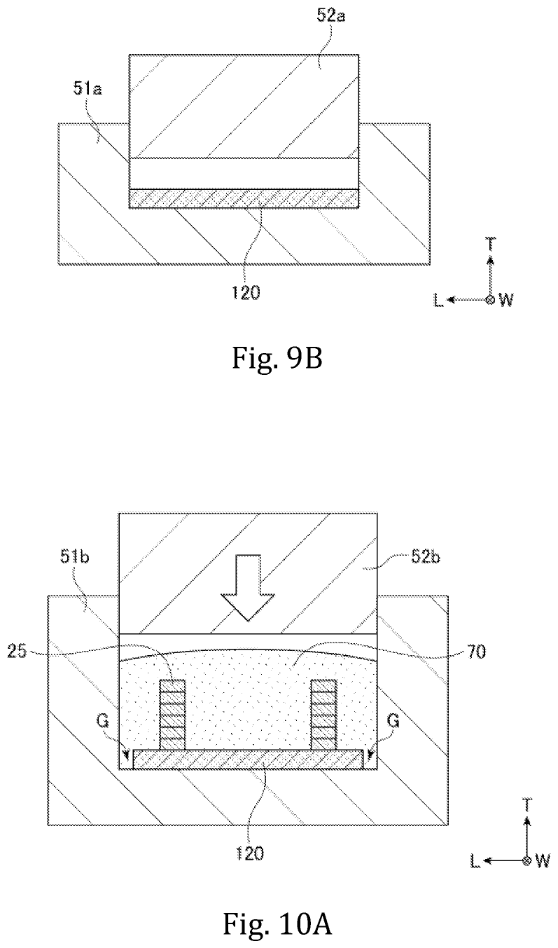

FIG. 8B shows the sub-steps included in the step S11 of fabricating the base body 10, or a flow chart presenting an example process of manufacturing a molded body that is a precursor to be turned into the base body 10 using compression molding. FIGS. 9A, 9B, 10A and 10B each schematically show one of the steps of the manufacturing process of the base body 10. In the example shown in FIGS. 9A to 10B, the base body 10 has the main body portion 11, the protruding portion 12, and the plate-shaped core 20. FIGS. 9A and 9B show the steps of making a precursor 120 to be formed into the plate-shaped core 20, and FIGS. 10A and 10B show the steps of fabricating the main body portion 11 having the coil conductor 25 provided therein and also fabricating the protruding portion 12.

To produce the base body 10, a magnetic material 60 is prepared in a step S11A to make a precursor of the plate-shaped core 20 (a precursor 120 shown in FIG. 9B). The magnetic material 60 is produced by mixing and kneading a first source powder with a first thermosetting resin and a diluting solvent. The first source powder may be, for example, the first magnetic powder described above. The first source powder is processed into the first metal magnetic particles 31 in a finished product or the coil component 1. The first source powder has a high circularity. The first source powder has a circularity of, for example, 0.9 or greater. The first thermosetting resin for the magnetic material 60 may be, for example, a polyvinyl butyral (PVB) resin, an epoxy resin, a silicone resin, or any other known resins. The first source powder may be a powder mixture of the first magnetic powder and one or more different magnetic powders (e.g., at least one of the second magnetic powder, the third magnetic powder, or the fourth magnetic powder). The first source powder may contain at least one of alumina particles or silica particles.

In the next step S11B, the magnetic material 60 is placed in the cavity of a die 51a and a first-stage molding is performed, as shown in FIG. 9A. In this manner, the precursor 120 is obtained. Specifically, after the magnetic material 60 is placed in the cavity, a punch 52a is moved downward in a stroke direction extending along the T-axis direction, so that the magnetic material 60 is compressed with a first molding pressure. The die 51a and punch 52a are shown as an example in FIG. 9A, and any other molds than the die 51a and punch 52a shown in FIG. 9A can be used in the first-stage molding. For example, the die 51a may be open toward the positive and negative sides in the T-axis direction (i.e., the upper and lower sides in the drawing). In this case, the punch 52a may include a pair of punches that face each other in the T-axis direction and can move along the T-axis direction. The first molding pressure can be within the range of 5 to 100 MPa. By compressing the magnetic material 60 in the above-described manner, the precursor 120 of the plate-shaped core 20 is fabricated as shown in FIG. 9B.

In the next step S11C, a magnetic material 70 is prepared to be used in a second-stage molding. The magnetic material 70 is produced by mixing and kneading a second source powder with a second thermosetting resin and a diluting solvent. The second source powder may be the same magnetic powder as the first source powder. For example, the second source powder may be the first magnetic powder described above. The second source powder is processed into the first metal magnetic particles 31 in a finished product or the coil component 1. The second source powder has a high circularity. The second source powder has a circularity of, for example, 0.9 or greater. The second thermosetting resin for the magnetic material 70 may be, for example, a polyvinyl butyral (PVB) resin, an epoxy resin, a silicone resin, or any other known resins. The second source powder may be a powder mixture of the first magnetic powder and one or more different magnetic powders (e.g., at least one of the second magnetic powder, the third magnetic powder, or the fourth magnetic powder). The second source powder may contain at least one of alumina particles or silica particles.

In the subsequent step S11D, the precursor 120 made in the step S11A and the magnetic material 70 are formed into a molded body through a second-stage molding. The molded body is a precursor to be formed into the base body 10. More specifically, as shown in FIG. 10A, the precursor 120 of the plate-shaped core 20 is placed in the cavity of a die Sib, which is different from the die 51a. When seen in the stroke direction (T-axis direction), the cavity of the die 51b has a larger area than the precursor 120 of the plate-shaped core 20. For example, the dimensions of the cavity of the die 51b in the L- and W-axis directions are greater than the corresponding dimensions of the die 51a. Accordingly, when the precursor 120 is placed in the cavity of the die Sib, a gap G is left between the precursor 120 and the side wall of the die 51b defining the cavity. The precursor 120 may be placed such that, when viewed in the stroke direction (T-axis direction), the gap G between the outer edge of the precursor 120 and the side wall of the die 51b can have a uniform dimension.

Following this, the coil conductor 25, which is prepared in advance, is placed on the precursor 120. The coil conductor 25 is placed in the cavity of the die such that the coil axis Ax coincides or substantially coincides with the stroke direction of the punch 51b. The coil axis Ax can be determined to substantially coincide with the stroke direction as long as the angle formed between the coil axis and the stroke direction of the punch is equal to or less than 30 degrees.

Subsequently, the magnetic material 70 is placed in the cavity of the die 51b, where the precursor 120 and the coil conductor 25 are placed. The gap G between the outer edge of the precursor 120 and the side wall of the die 51b may be filled with the magnetic material 70. If the gap G only has a small dimension, it may not be necessary to fill the gap G with the magnetic material 70.

After the magnetic material 70 is placed in the cavity, a punch 52b is moved downward in the stroke direction, so that the precursor 120 and the magnetic material 70 in the cavity are compressed with a second molding pressure. The second molding pressure is less than the first molding pressure. The second molding pressure can be within the range of 5 to 100 MPa, for example.

After the pressure is applied in the second-stage molding, the die 51b may be heated so that the temperature in the cavity of the die 51b rises to a temperature equal to or higher than the curing temperature of the first thermosetting resin contained in the magnetic material 60 and the second thermosetting resin contained in the magnetic material 70. In other words, the heating of the step S12 can immediately follow the second-stage molding of the step S11D. The heating processes the precursor 120 into the plate-shaped core 20, and also processes the molded and compressed magnetic material 70 into the main body portion 11 and the protruding portion 12. The plate-shaped core 20 is an example of the feature “a first portion” as set forth in the claims, and the combination of the main body portion 11 and protruding portion 12 is an example of the feature “a second portion” as set forth in the claims. The plate-shaped core 20 is solely presented as an example of the first portion, and the first portion is not limited to the plate-shaped core 20. Similarly, the combination of the main body portion 11 and the protruding portion 12 is presented only as an example of the second portion, and the second portion is not limited to the combination of the main body portion 11 and the protruding portion 12.

The first magnetic powder in the first and second source powders is compressed in the first- and second-stage molding steps into the first metal magnetic particles 31. As shown in FIG. 11, the first magnetic powder 31a contained as the first source powder in the magnetic material 60 and the first magnetic powder 31b contained as the second source powder in the magnetic material 70 are compressed into the first metal magnetic particles 31. The first metal magnetic particles 31 resulting from the compressing of the first magnetic powder 31a are contained in the plate-shaped core 20, and the first metal magnetic particles 31 resulting from the compressing of the first magnetic powder 31b are contained in the main body portion 11 or protruding portion 12.

The first metal magnetic particles 31 contained in the plate-shaped core 20 have an average circularity greater than 0.8. Similarly, the first metal magnetic particles 31 contained in the main body portion 11 or protruding portion 12 have an average circularity greater than 0.8. Since the first molding pressure is greater than the second molding pressure, the average circularity of the first metal magnetic particles 31 contained in the plate-shaped core 20 is less than the average circularity of the first metal magnetic particles 31 contained in the main body portion 11, but the average circularity of the first metal magnetic particles 31 contained in the plate-shaped core 20 is still greater than 0.8.

The first- and second-stage molding steps apply the molding pressure along the T-axis. Accordingly, the first metal magnetic particles 31 are compressed so that their dimension in the direction along the T-axis (pressing direction) is less than their dimension in the direction perpendicular to the T-axis. As described above, the difference between the average circularity (first source material average circularity) of the first magnetic powder 31a, which is the source powder, and the first average circularity of the first metal magnetic particles 31 in the plate-shaped core 20 may be equal to or less than 10% of the first source material average circularity. In a case where the first magnetic powder 31a, which is the source powder, has an average circularity of 0.85 and the difference between the first source material average circularity and the first average circularity of the first metal magnetic particles 31 is 10% or less, the first metal magnetic particles 31 have an aspect ratio of less than 1.33. The difference between the average circularity (the first source material average circularity) of the first magnetic powder 31a, which is the source powder, and the first average circularity of the first metal magnetic particles 31 may be equal to or less than 5% of the first source material average circularity. In a case where the difference between the first source material average circularity and the first average circularity of the first metal magnetic particles 31 is 5% or less, the first metal magnetic particles 31 have an aspect ratio of less than 1.15. The difference between the average circularity (the first source material average circularity) of the first magnetic powder 31a, which is the source powder, and the first average circularity of the first metal magnetic particles 31 may be equal to or less than 3% of the first source material average circularity. In a case where the difference between the first source material average circularity and the first average circularity of the first metal magnetic particles 31 is 3% or less, the first metal magnetic particles 31 have an aspect ratio of less than 1.1.

What has been described about the relation between the average circularity of the first magnetic powder 31a and the first average circularity of the first metal magnetic particles 31 contained in the plate-shaped core 20 also applies to the relation between the average circularity of the first magnetic powder 31b and the first average circularity of the first metal magnetic particles 31 contained in the main body portion 11 and the protruding portion 12. More specifically, the difference between the average circularity (second source material average circularity) of the first magnetic powder 31b, which is the source powder, and the first average circularity of the first metal magnetic particles 31 contained in the main body portion 11 and the protruding portion 12 may be equal to or less than 10% of the first source material average circularity, 5% of it, or 3% of it.

The second-stage molding may use the same die 51a and punch 52a as the first-stage molding. In this case, the base body 10 may contain no protruding portion 12.

The step S12 may be performed after the precursor of the base body 10 is removed from the die 51b. In this case, the precursor of the base body 10 that has been removed from the die 51b is heated at a temperature equal to or higher than the curing temperature of the first and second thermosetting resins.

In the next step S13, a conductor paste is applied to the surface of the base body 10, which is obtained in the step S12, to form the external electrodes 21 and 22. The external electrode 21 is electrically connected to one of the ends of the coil conductor 25 placed within the base body 10, and the external electrode 22 is electrically connected to the other end of the coil conductor 25 placed within the base body 10. The external electrodes 21 and 22 may include a plated layer. There may be two or more plated layers. The two plated layers may include an Ni plated layer and an Sn plated layer externally provided on the Ni plated layer. Alternatively, the coil conductor 25 may be placed such that its ends are exposed out of the base body 10, and the exposed portions of the coil conductor 25 are bent toward the bottom surface 10b, so that the exposed portions of the coil conductor 25 form the external electrodes.

In the above-described manner, the coil component 1 is completed. The manufactured coil component 1 may be mounted on the mounting substrate 2a using a reflow process. In this process, the mounting substrate 2a having the coil component 1 thereon passes at a high speed through a reflow furnace heated to, for example, a peak temperature of 260° C., and then the external electrodes 21, 22 are soldered to the corresponding lands 3 of the mounting substrate 2a. In this way, the coil component 1 is mounted on the mounting substrate 2a, and thus the circuit board 2 is manufactured.

Advantageous effects of the above embodiments will now be described. According to at least one embodiment of the present invention, the first average circularity of the first metal magnetic particles 31 contained in the base body 10 is greater than 0.8. This means reduced strain in the first metal magnetic particles 31. The stress strain in the first metal magnetic particles 31 may lead to core loss and to a drop in magnetic permeability of the base body 10, but the embodiments can mitigate such problems. Since the first group of metal magnetic particles have the high first average circularity, the first metal magnetic particles 31 can touch each other at a small area. This can lower the likelihood of electrical breakdown between the first metal magnetic particles 31. Accordingly, the base body 10 relating to the embodiment of the present invention can achieve raised specific resistance. As the first average circularity of the first group of metal magnetic particles is 0.8 or higher, this can prevent the first metal magnetic particles 31 from aggregating. If the first metal magnetic particles 31 aggregate, the filling factor of the metal magnetic particles in the base body 10 drops. The embodiments of the present invention can mitigate this problem.

According to at least one embodiment of the present invention, the base body 10 contains the first group of metal magnetic particles having the first average particle size and the second group of metal magnetic particles having the second average particle size smaller than the first average particle size. Therefore, the second metal magnetic particles get into the gaps between the first metal magnetic particles 31. This can lead to a high filling factor of the metal magnetic particles in the base body 10.

According to at least one embodiment of the present invention, the first average circularity of the first group of metal magnetic particles is greater than 0.8, and the second average circularity of the second group of metal magnetic particles is greater than the first average circularity. Therefore, the first metal magnetic particles 31 and the second metal magnetic particles both have a small surface area, which is attributable to their circularity. Since the first and second metal magnetic particles both have a small surface area attributable to their circularity, the metal magnetic particles can be prevented from aggregating in the base body 10. If the metal magnetic particles aggregate, the filling factor of the metal magnetic particles may drop. The embodiments of the present invention can mitigate such problems. According to at least one embodiment of the present invention, the second metal magnetic particles having a relatively small diameter exhibit a higher circularity than the first metal magnetic particles having a relatively large diameter. Therefore, the second metal magnetic particles, which are more likely to aggregate than are the first metal magnetic particles, can be prevented from aggregating.

According to at least one embodiment of the present invention, the first metal magnetic particles 31 and the second metal magnetic particles contain Si, so that the first metal magnetic particles 31 and the second metal magnetic particles have a low magnetic crystalline anisotropy constant and a low magnetostriction constant. This can contribute to reduce the coercive force in the first metal magnetic particles 31 and second metal magnetic particles. As a result, the hysteresis loss can be reduced. Since the first metal magnetic particles 31 and second metal magnetic particles contain Si, the first metal magnetic particles 31 and second metal magnetic particles can have high electrical resistivity. This can reduce the eddy current loss in the first metal magnetic particles 31. Since the Si content is greater in the first metal magnetic particles 31 than in the second metal magnetic particles, an eddy current loss can be effectively prevented in the first metal magnetic particles 31, which are more likely to cause an eddy current due to their large diameter.

According to at least one embodiment of the present invention, the average circularity of the first metal magnetic particles 31 included in the core area 10X, where a high density of magnetic flux is observed when a current flows through the coil conductor 25, is less than the average circularity of the first metal magnetic particles 31 included in the margin area 10Y. This can further improve the magnetic permeability of the base body 10.

According to at least one embodiment of the present invention, the third metal magnetic particles can fill the gaps between the first metal magnetic particles, the gaps between the second metal magnetic particles, and the gaps between the first metal magnetic particles and the second metal magnetic particles. As a result, the base body 10 can have enhanced mechanical strength.

According to at least one embodiment of the present invention, the third metal magnetic particles can more fully fill the gaps between the first metal magnetic particles, the gaps between the second metal magnetic particles, and the gaps between the first metal magnetic particles and the second metal magnetic particles. As a result, the base body 10 can achieve enhanced filling factor of the metal magnetic particles.

According to the manufacturing method relating to at least one embodiment of the present invention, the compression molding step is performed such that the difference between the source material average circularity, which represents the average circularity of the source magnetic powder, and the first average circularity of the first metal magnetic particles 31 can be equal to or less than 10% of the source material average circularity. This can prevent the compression molding step from causing stress strain in the first metal magnetic particles 31.

Coil components used in highly severe environments (e.g., automotive electrical components and servers) are required to have low strain in the coil conductors. In the compression molding step, the coil conductor and the source material are placed in the mold, and a molding pressure may be also applied to the coil conductor. The manufacturing method according to at least one embodiment of the present invention employs a low molding pressure of 5 MPa to 100 MPa, while the conventional compression molding step uses a molding pressure of 400 to 800 MPa. According to the manufacturing method according to at least one embodiment of the present invention, a lowered pressure is applied to the coil conductor. In this manner, the coil conductor may only experience reduced strain.

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

This specification also discloses the following embodiments.

### Additional Embodiment 1

A coil component comprising:
a base body including a first group of metal magnetic particles and a resin binder, the first group of metal magnetic particles having a plurality of first metal magnetic particles, the first group of metal magnetic particles having a first average circularity greater than 0.8, each of the first metal magnetic particles containing a main component and an additive, the main component including at least one of Fe or Ni, the additive accounting for less than 10 wt %;
a coil conductor provided in the base body;
a first external electrode electrically connected to the coil conductor; and
a second external electrode electrically connected to the coil conductor.

### Additional Embodiment 2

The coil component of Additional Embodiment 1, wherein the additive contains Si.

### Additional Embodiment 3

The coil component of Additional Embodiment 1 or 2, wherein the base body further includes a second group of metal magnetic particles including a plurality of second metal magnetic particles, the second metal magnetic particles containing Si, the second group of metal magnetic particles having a second average circularity greater than 0.8.

### Additional Embodiment 4

The coil component of Additional Embodiment 2 or 3,
wherein an Si content is lower in the second metal magnetic particles than in the first metal magnetic particles, and
wherein the second average circularity is greater than the first average circularity.

### Additional Embodiment 5

The coil component of Additional Embodiment 3 or 4, wherein the base body further includes a third group of metal magnetic particles including a plurality of third metal magnetic particles, the third metal magnetic particles containing Si, the third group of metal magnetic particles having a third average circularity greater than 0.8.

### Additional Embodiment 6

The coil component of Additional Embodiment 5,
wherein an Si content is lower in the third metal magnetic particles than in the second metal magnetic particles, and
wherein the third average circularity is greater than the second average circularity.

### Additional Embodiment 7

A method of manufacturing a coil component, the method comprising steps of:
preparing a magnetic material containing a magnetic powder and a thermosetting resin;
applying a molding pressure to the magnetic material and a coil conductor to produce a molded body;
heating the molded body at a heating temperature equal to or higher than a curing temperature of the thermosetting resin into a base body; and
providing an external electrode on the base body,
wherein the molded body includes a first group of metal magnetic particles, the first group of metal magnetic particles having a plurality of first metal magnetic particles made from the magnetic powder, the first group of metal magnetic particles having a first average circularity greater than 0.8, and
wherein a difference between a source material average circularity representing an average circularity of the magnetic powder and the first average circularity is equal to or less than 10% of the source material average circularity.

### Additional Embodiment 8

The method of Additional Embodiment 7, wherein the molding pressure is from 5 MPa to 100 MPa.

### Additional Embodiment 9

A method of manufacturing a coil component, the method comprising steps of:
applying a first molding pressure to a first magnetic material into a first molded body, the first magnetic material containing a first source powder and a first thermosetting resin;
applying a second molding pressure to the first molded body and a second magnetic material covering a coil conductor placed on the first molded body into a second molded body, the second magnetic material containing a second source powder and a second thermosetting resin;
heating the first molded body and the second molded body at a heating temperature that is equal to or higher than a curing temperature of the first thermosetting resin and equal to or higher than a curing temperature of the second thermosetting resin into a base body, the base body including a first portion resulting from the first molded body and a second portion resulting from the second molded body; and
providing an external electrode on the base body,
wherein the first portion includes a plurality of first portion metal magnetic particles made from the first source powder,
wherein the first portion metal magnetic particles have a first portion average circularity greater than 0.8,
wherein a difference between (i) a first source material average circularity representing an average circularity of the first source powder and (ii) the first portion average circularity is equal to or less than 10% of the first source material average circularity,
wherein the second portion contains a plurality of second portion metal magnetic particles made from the second source powder,
wherein the second portion metal magnetic particles have a second portion average circularity greater than 0.8, and
wherein a difference between (i) a second source material average circularity representing an average circularity of the second source powder and (ii) the second portion average circularity is equal to or less than 10% of the first source material average circularity.

### Additional Embodiment 10

The method of Additional Embodiment 9, wherein the first molding pressure is from 5 MPa to 100 MPa.

### Additional Embodiment 11

The method of Additional Embodiment 10, wherein the second molding pressure is less than the first molding pressure.

### Additional Embodiment 12

The method of any one of Additional Embodiments 7 to 11, wherein the heating temperature is lower than 200° C.

### Additional Embodiment 13

A circuit board comprising the coil component of any one of Additional Embodiments 1 to 6.

### Additional Embodiment 14

An electronic component comprising the circuit board of Additional Embodiment 13.

What is claimed is:

1. A coil component comprising:
a base body including a first group of metal magnetic particles and a resin binder, the first group of metal magnetic particles having a plurality of first metal magnetic particles, the first group of metal magnetic particles having a first average circularity greater than 0.8, each of the first metal magnetic particles containing a main component and an additive, the main component including at least one of Fe or Ni, the additive accounting for less than 10 wt %;
a coil conductor provided in the base body;
a first external electrode electrically connected to the coil conductor; and
a second external electrode electrically connected to the coil conductor.

2. The coil component of claim 1, wherein the additive contains Si.

3. The coil component of claim 1, wherein the base body further includes a second group of metal magnetic particles including a plurality of second metal magnetic particles, the second metal magnetic particles containing Si, the second group of metal magnetic particles having a second average circularity greater than 0.8.

4. The coil component of claim 3,
wherein an Si content is lower in the second metal magnetic particles than in the first metal magnetic particles, and
wherein the second average circularity is greater than the first average circularity.

5. The coil component of claim 3, wherein the base body further includes a third group of metal magnetic particles including a plurality of third metal magnetic particles, the third metal magnetic particles containing Si, the third group of metal magnetic particles having a third average circularity greater than 0.8.

6. The coil component of claim 5,
wherein an Si content is lower in the third metal magnetic particles than in the second metal magnetic particles, and
wherein the third average circularity is greater than the second average circularity.
